(19) United States
(12) Patent Application Publication
(10) Pub. No.: US 2008/0071839 A1
(43) Pub. Date: Mar. 20, 2008

(54) Content authoring

(76) Inventors: Juergen Sattler, Wiesloch (DE); Joachim Gaffga, Wiesloch (DE); Werner Wolf, Wiesloch (DE); Robert Viehmann, Waghausl (DE); Frank Markert, Grossostheim (DE); Steffen Riemann, St. Leon-Rot (DE)

Correspondence Address: SCHWEGMAN, LUNDBERG & WOESSNER/SAP, P.O. BOX 2938, MINNEAPOLIS, MN, 55402, US

(21) Appl. No.: 11/512,609

(22) Filed: Aug. 29, 2006

(51) Int. Cl. G06F 17/30

(52) U.S. Cl. 707/200

(57) ABSTRACT

The present subject mater relates to configuring software applications and, more particularly, content authoring of content within software applications. The various embodiments described herein provide systems, methods, and software to provide one or more user interfaces operable within an application. The user interfaces receive input creating, modifying, and deleting content, store and retrieve content from one or more content repositories in a memory device, and receive input. In some embodiments, this input defines one or more of scoping content, configuration content, and links between scoping content and configuration content.

### TECHNICAL FIELD

The present subject mater relates to configuring software applications and, more particularly, content authoring of content within software applications.

### BACKGROUND INFORMATION

Configuring many software applications, such as enterprise resource planning (“ERP”) application, is a large and complex task. Because of the scale of many of these applications, identifying configuration issues and optimizing the configuration can be even more difficult. Many times, even if an issue is identified, administrators are often hesitant to modify the configuration if the application otherwise remains operational. When such applications are not optimized or need to be modified, the total cost of application ownership increases.

### BRIEF DESCRIPTION OF THE DRAWINGS

FIG. 1 is a block diagram of a system according to an example embodiment.

FIG. 2A is a block diagram of a system according to an example embodiment.

FIG. 2B is a block diagram of a system according to an example embodiment.

FIG. 2C is a block diagram of a system according to an example embodiment.

FIG. 2D is a block diagram of a system according to an example embodiment.

FIG. 2E is a block diagram of a system according to an example embodiment.

FIG. 3 is a block diagram of a system according to an example embodiment.

FIG. 4-FIG. 22 illustrate user interfaces according to example embodiments.

FIG. 23 is a flow diagram of a method according to an example embodiment.

FIG. 24 is a block diagram of a system according to an example embodiment.

### DETAILED DESCRIPTION

The various embodiments described herein provide systems, methods, and software to author and distribute content to software applications. The content, in some embodiments, may include an arrangement of data that may be used to rapidly configure software applications, application functionality, data, form definitions, report definitions, user interface definitions, packages of application functionality that include one or more other content types, and other content types that can be used within a software application.

In some embodiments, a baseline application, such as an instantiated, but unconfigured, enterprise resource planning (“ERP”) application, may delivered with built-in, predefined content in many business areas, for example covering standards, best business practices, legal settings, analytics (including reports) and business networking according to the requirements of the targeted countries and industries. Predefined content typically reduces complexity and attacks may of the main cost drivers in implementation, operations, and maintenance. Ultimately, with the help of predefined content in conjunction with an underlying toolset, the application may be deployed in an out-of-the-box approach and may be productively used after minimal implementation time.

In such embodiments, to cover consistent end-to-end processes, predefined content typically consists of predefined settings, e.g.
Business Content (process, functional, master data, organization, work flow, etc)
User Interface (roles, Control Center/Work Center)
Forms and Reports (print forms/office templates, reports)
Business Process Modeling (scenarios and processes)
Knowledge Management (training material, documentation

### In addition to the configuration, predefined content may also include sample data aligned with the predefined end-to-end processes.

In some embodiments, predefined content and a set of configuration tools together may play a role in minimizing the implementation effort. Predefined content reduces the customer's effort for content definition, while the usability of the configuration tools enables straightforward adjustments whenever necessary.

Some embodiments may further provide the ability to author content utilizing one or more content authoring tools and publishing the content. In some such embodiments, the content may be associated with configuration settings and/or scoping information. This information may then be utilized to identify one or more application deployments to publish the content to.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, electrical, or other changes may be made without departing from the scope of the inventive subject matter. Such embodiments of the inventive subject matter may be referred to, individually and/or collectively, in the present application by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described in the present application are implemented in hardware, software or a combination of software and hardware in one or more embodiments. The software comprises computer executable instructions stored on computer readable media such as memory or other type of storage devices. The term “computer readable media” is also used to represent carrier waves on which the software is transmitted. Further, such functions correspond to modules, which may be one or more, or a combination of, software, hardware, or firmware. Multiple functions are performed in one or more modules as desired, and the embodiments described are merely examples. The software may be executed on a digital signal processor, ASIC, microprocessor, or other type of processor operating on a system, such as a personal computer, server, a router, or other device capable of processing data including devices interconnected by a network.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

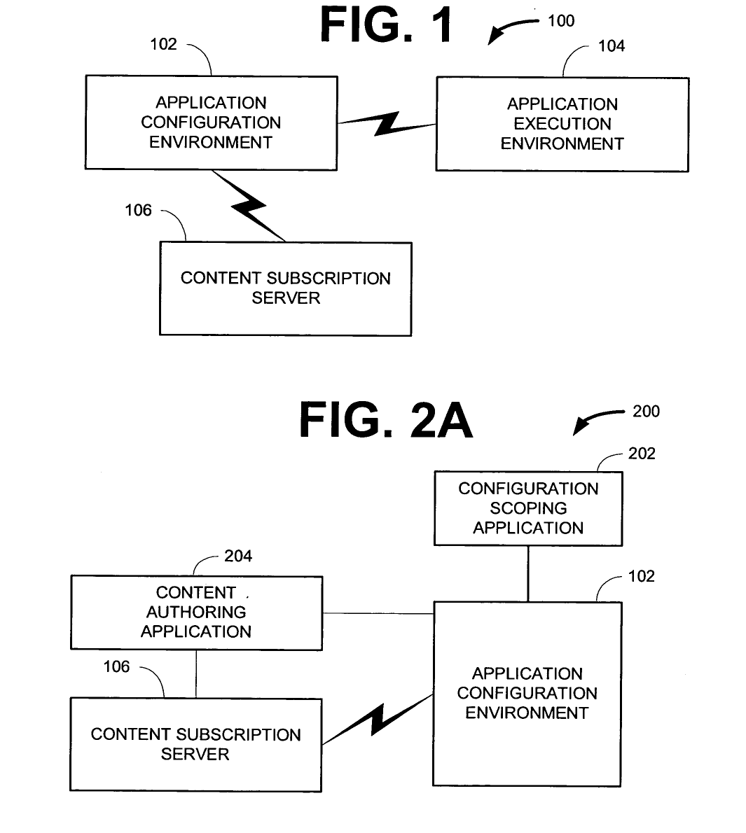

FIG. 1 is a block diagram of a system 100 according to an example embodiment. The system 100 includes an application configuration environment 102, an application execution environment 104, and a content subscription server 106.

The application configuration environment 102 is a system 100 environment within which an application may be configured. However, the application will, or does, execute within the application execution environment 104. In some embodiments, this arrangement of the application configuration environment 102 and the application execution environment 104 separates the configuration of an application from the environment within which it executes. When an application configuration has been established, all or part of the configuration may then be deployed to the application execution environment 104. This deployment may occur to one or more separate instances of the application in the application execution environment 104. Although only a single application execution environment 104 is illustrated, multiple application execution environments 104 may exist, and the deployment may be made to one or more of the multiple application execution environments 104.

The content subscription server 106 receives content updates and new content from content authors, or through a content authoring process, then publishes the content to the content subscription server 106. When content is published to the content subscription server 106, the content includes metadata identifying what portions of an application the content is relevant to or otherwise has an effect upon. In some embodiments, the metadata identifies a version of an item of content, such as version 2.0 of a previously existing item of content. In such instances, the new version of the content is backward compatible with previous versions of the application instance to ensure that new content does not adversely affect a previously stable application instance.

The content subscription server 106 further includes a database, or has access to a database, including data representative of application instance configurations. In some such embodiments, the data representative of the application instance configurations includes data representative of content deployed to the respective application instances.

The content subscription server 106 further includes a content subscription module that evaluates the metadata of received content updates and new content. As mentioned above, this metadata identifies application portions of the application the content is relevant to or otherwise has an effect upon. The content subscription module may then query the database including the representations of application instance configurations to determine which application instances the new content is relevant to. The new content may then be distributed to the application configuration environments of the identified application instances. The application configuration environment may then deploy the new content.

In some embodiments, the content subscription server 106 further includes a database of content subscription preferences. In some such embodiments, when an application instance is instantiated, an application administrator, or other individual, sets up a content subscription. A content subscription includes a specification of content subscription preferences that are stored in the content subscription preference database. These preferences identify how to handle new content when new content is published to the content subscription server 106.

In some embodiments, the content subscription preferences specify that new content that is identified by the content subscription module to be relevant to the application instance be pushed to the application configuration environment 102 over a network, such as the Internet. In some such embodiments, when new content is pushed to the application configuration environment, a content subscription preference specifies that the new content be automatically deployed to the application execution environment 104 by a deployment process. In other embodiments, the preferences specify that the pushed content is to be stored in an administrator inbox. In these embodiments, the administrator, or other individual will manually instruct the deployment module to deploy the new content. In some other embodiments, a content subscription preference specifies for the new content to be placed in a new content inbox. The new content inbox may be located on the content subscription server 106 or other server from which the new content can be accessed for download.

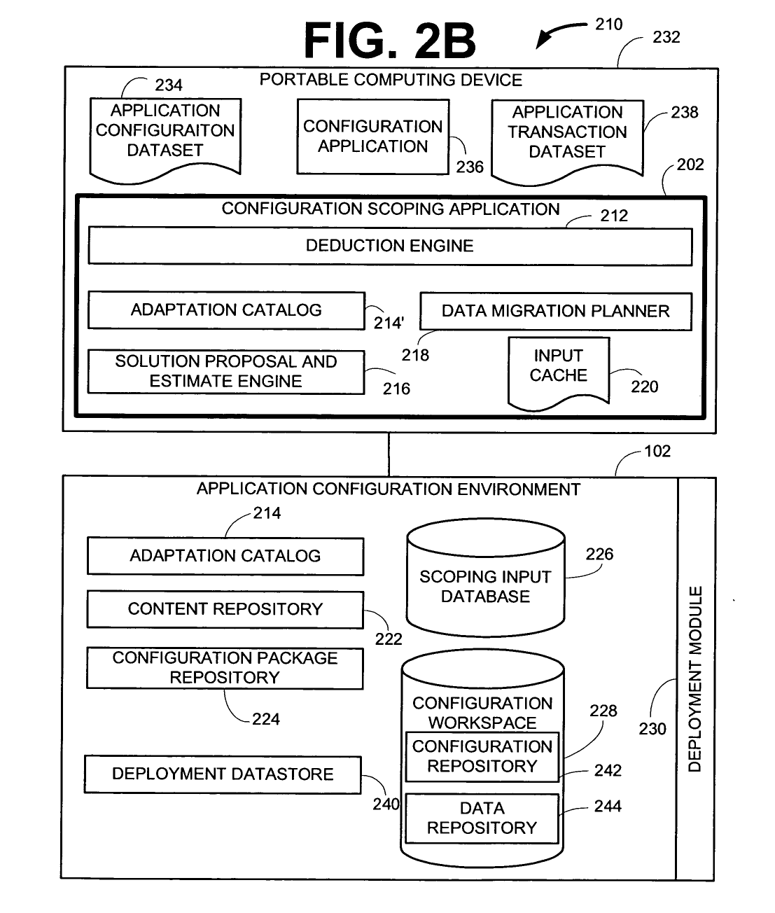

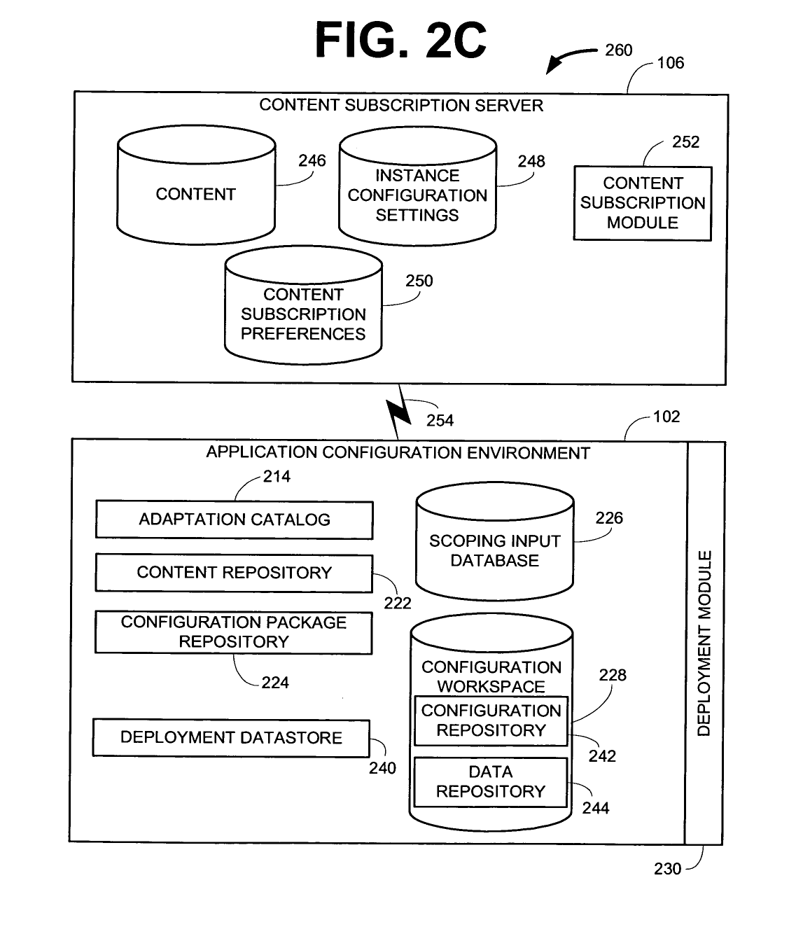

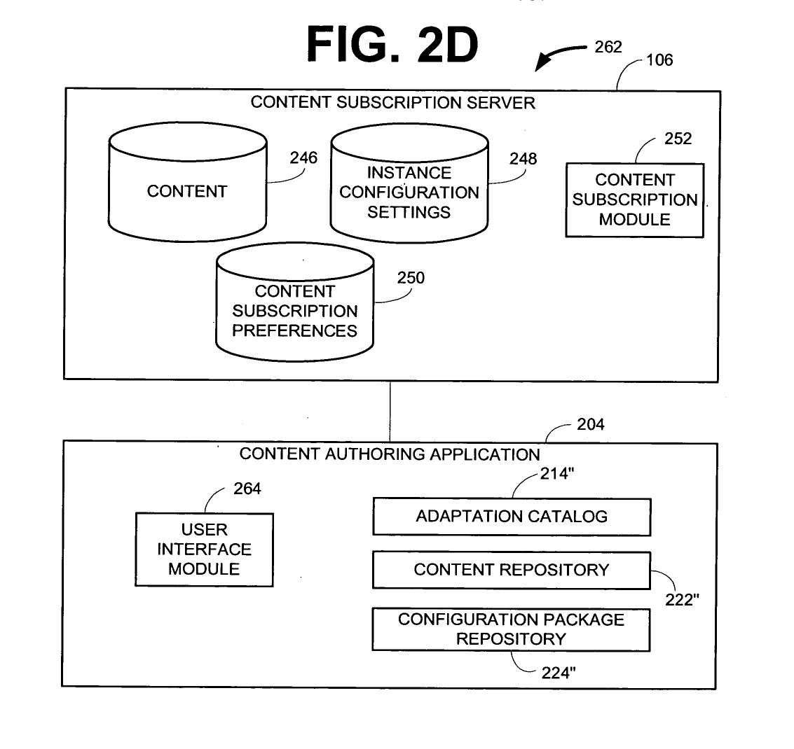

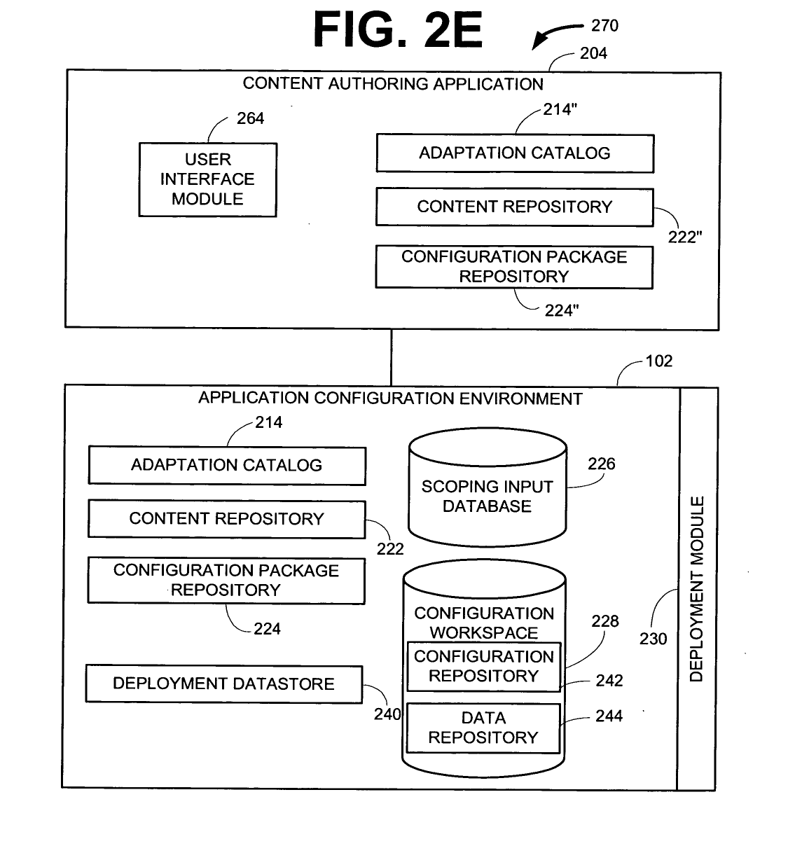

FIG. 2A is a block diagram of a system 200 according to an example embodiment. The system 200 includes a configuration scoping application 202, the application configuration environment 102, the content authoring application 204, and the content subscription server 106.

The configuration scoping application 202 typically is a software tool that executes on a computing device, such as a portable computer, on a same computing device within which the application configuration environment 102 exists, or on another computing device that can be communicatively coupled to the application configuration environment 102.

The configuration scoping application 202, when executed, typically presents a set of scoping questions to a user. The scoping questions may be linked to one of many adaptation catalog entries. The adaptation catalog entries may include a representation of all of the solution capabilities of an application to be configured, and eventually executed. In some embodiments, the solution capabilities are hierarchically divided into areas, packages, topics, and options. There may be multiple areas, and each area may have multiple packages. Each package may have multiple topics, and each topic may have multiple options.

In some embodiments, such as in an example embodiment where the application to be configured is an ERP application, the adaptation catalog may provide in the area Sales, a package Customer Order Management that contains the topics Sales Order Quote, Sales Order, Sales Order Analysis, and others. On that level, one or more options typically exist such as Approval Processing.

In the configuration scoping application 202, as stated above, scoping question may be linked to an adaptation catalog entry. An adaptation catalog entry further includes a rule. These rules typically model dependencies between the areas, packages, topics, and options and corresponding solution capabilities of the application. A rule may specify required inclusion or exclusion of other areas, packages, topics, or options, or may require specification of further areas, packages, topics, or options. A rule may also specify a recommendation or default area, package, topic, or option.

For example, a first example scoping question, “What is the primary focus of your business?” may have three possible answers including “Sales,” “Service,” and “Logistics.” Such a first scoping question typically is aimed at identifying an area of business in which the application is going to be used. Answering “Sales” typically tells the configuration scoping application 202 that the area is “Sales” and a rule tied to the adaptation catalog entry for “Sales” specifies dependencies with packages, topics, and options and the corresponding solution capabilities of the application necessary or optional in using the application in a sales business. Such a rule can also specify that other packages, topics, and options and the corresponding solution capabilities be excluded.

Thus, when a user answers scoping questions, the configuration of the application is being performed. Further, when a question is answered that is associated with an adaptation catalog entry having a rule that excludes another area, package, topic, or option, that rule may be applied to eliminate questions from consideration. Conversely, when a question is answered that is associated with an adaptation catalog entry having a rule that requires another area, package, topic, or option, that same rule may be applied to determine a next question, or group of questions, to ask a user. However, in the event that a question is not answered that is linked to a rule providing defaults, the question may be skipped without adversely affecting the application configuration.

In some embodiments, the answers to the scoping question answers may be stored in a location accessible to the content subscription server 106. This may include storing the scoping question answers on the content subscription server 106 and the content subscription server 106 being able to access the scoping question answers within the application configuration environment 102.

The answers to the configuration scoping questions may be used by a content subscription module process to identify new and updated content that is relevant to one or more application instances. The identification of new and updated content that is relevant to one or more application instances may occur when the new or updated content includes new functionality not previously linked to a scoping question answer in the adaptation catalog.

The content authoring application 204 typically provides a set of tools to author content. The set of tools may be provided by the content authoring application 204 through one or more user interfaces. The content authoring application 204, in some embodiments, may be a standalone application. In other embodiments, the content authoring application 204 is configured to execute on a computing device operatively coupled to the content subscription server 106 and one or more application configuration environments 102. In other embodiments, the content authoring application 204 may be a portion of a larger application and does not require a connection to the content subscription server 106 or the application environment 102.

Content that may be created, modified, and deleted using the tools of the content authoring application 204 typically includes adaptation catalog entries, forms, user interfaces, reports, communication specifications, documentation, and other content that may be used in an application when deployed. In some embodiments, a communication specification may include an XML schema, an EDI schema and connectivity information, mappings between file layouts and application data storage mechanisms, such as databases, or other similar communication specifications.

FIG. 2B is a block diagram of a system 210 according to an example embodiment. The system 210 includes a portable computing device 232 including a configuration application 236, an application configuration dataset 234 stored in a memory, an application transaction dataset 238 and the configuration scoping application 202. The system 210 further includes the application configuration environment 102. Although the application configuration environment 102 is not illustrated within the portable computing device 232, in some embodiments, the application configuration environment 102 does reside within the portable computing device 232. In other embodiments, the application configuration environment 102, the configuration scoping application 202, the application configuration dataset 234, the configuration application 236, and the application transaction dataset 238 all reside on a computing device other than the portable computing device 232.

The configuration application 236, in some embodiments, typically provides a set of tools via user interfaces to a user. The tools of the configuration application 236 may allow the user to modify answers to scoping question answers stored in an input cache 220 of the configuration scoping application 202, the application configuration dataset 234, and the application transaction dataset 238. The application configuration dataset 234 may be populated with data copied from a configuration repository 242 stored within a configuration workspace 228 of the application configuration environment 102. The application transaction dataset 238 may be populated with data copied either from a demonstration dataset stored in data repository 244 of the configuration workspace 228 or from the content repository 222.

Although the input cache 220 is illustrated within the configuration scoping application 202, the input cache 220 may exist separate from the configuration scoping application 202 within a memory of the portable computing device 232. In such embodiments, the input cache 220 may be populated with data copied from the scoping input database 226.

For the sake of understandability regarding several portions of the configuration scoping application 202 and the application configuration environment 102, these portions of the system 210 will be discussed followed by a more detailed discussion of the configuration application 236.

The configuration scoping application 202, in some embodiments, includes a deduction engine 212 and an adaptation catalog 214′. In this embodiment, the configuration scoping application 202 further typically includes a solution proposal and estimate engine 216, a data migration planner 218, and the input cache 220.

The application configuration environment 102, in some embodiments, includes an adaptation catalog 214, a content repository 222, and a configuration package repository 224. In some such embodiments, the application configuration environment 102 further includes a scoping input database 226, a configuration workspace 118, a deployment module 230, and a deployment datastore 240.

The adaptation catalog 214 may include a representation of all of the solution capabilities of an application to be configured, and eventually executed. Each capability of an application to be configured is identified in an adaptation catalog 214 entry. The adaptation catalog 214 entries each may be identified as an area, package, topic, or option and may be organized in a hierarchy with a child identifying the parent. An example hierarchy is a “General Ledger” capability, which in some embodiments typically is a package having two topics, “cash based” and “accrual based” which are two application capabilities within the “General Ledger” capability.

The adaptation catalog 214 entries may further include scoping questions directed toward obtaining scoping information to determine what areas, packages, topics, and options are relevant to the user's needs. Additionally, the adaptation catalog entries typically include rules, the application of which can require inclusion or exclusion, or specify default inclusion or exclusion, of certain other areas, packages, topics, and options. Thus, because the areas, packages, topics, and options correlate to application capabilities, the inclusion, exclusion, and defaulting specifies what capabilities will be enabled and disabled in the application when deployed by the deployment module 230.

In some embodiments, rules and entries in the adaptation catalog can be linked to a configuration package that exists in the configuration package repository 224. A configuration package includes one or more configuration settings that enable or disable functionality of the application when deployed by the deployment module 230 or by a configuration process within the application configuration environment 102 when configuring the application within the configuration workspace 228. A configuration package can further be linked to one or more content items or content item definitions stored in the content repository 222. Some such content types include report layouts, forms, user interfaces, communication specifications, documentation, and other content that can be used in an application when deployed. A communication specification can include an XML schema, an EDI schema and connectivity information, mappings between file layouts and application data storage mechanisms, such as databases, and other similar communication specifications.

The rules of adaptation catalog 214 entries may also be used by the deduction engine 212 of the configuration scoping application 202. The configuration scoping application 202 typically presents a user interface to a user that requests answers to questions. The questions to be asked via the user interface may be identified by the deduction engine 212 based on the adaptation catalog 214′. The adaptation catalog 214′ is typically a copy of the adaptation catalog 214 from the application configuration environment 102. When an answer is received by the configuration scoping application 202 through the user interface, the answer may be stored in the input cache 220 of the configuration scoping application 202. The deduction engine 212 may then apply the rule associated with the adaptation catalog 214′ entry of the question asked to the received answer. Through the application of the rule, in view of answers already received and rules already applied, the deduction engine 212 typically identifies a next question to ask. The identified question may then be presented to the user through the user interface. This process typically continues until either all of the questions have been asked, the user is out of time, or otherwise chooses to stop. If questions remain that have not been answered, the process may be continued at a later time or rules specifying default areas, packages, topics, and options typically supply enough information to allow deployment of the application in a functional form.

In some embodiments, the configuration scoping application 218 may further include a data migration planner 218. In such embodiments, one or more additional scoping questions may be asked. These additional scoping questions are typically directed toward obtaining information from the user about legacy systems and how data is stored within them. In some embodiments, the questions simply may ask what systems are currently in use. In other embodiments, the questions may be more detailed to obtain information such as what type of database an application is utilizing and what type of customization has been made or custom applications developed. The data migration planner 218 may then use the answers to these additional questions to propose a data migration plan to the new application.

In some embodiments, the configuration scoping application 202 includes a solution proposal and estimate engine 216. The solution proposal and estimate engine 216 may be used in a sales situation. For example, if a sales person is discussing with a sales lead what a certain application product can do for the sales lead, the sales person typically can utilize the configuration scoping application 202 to obtain information about the needs of the sales lead via the scoping questions. The scoping question answers may then be utilized by the solution proposal and estimate engine 216 to make an initial determination of what will be involved if the sales lead decides to purchase the application. The solution proposal and estimate engine 216 normally is configured to output information for the sales lead to make several determinations, such as the size of effort necessary to implement or transition to the application from legacy system, the cost involved, and cost. In some embodiments, the output of the solution proposal and estimate engine 216 outputs one or more of an implementation cost estimate, an application solution proposal, and a recommended project roadmap. In some embodiments, the solution proposal and estimate engine 216 outputs a proposal for one or more other options, application descriptions, sales literature, benefit statements of using the application, and addition documents, such as a proposal of key performance indicators the application can monitor to assist in managing the application or enterprise of the sales lead.

After the scoping question have been answered, the answers, and any other information obtained from a sales lead or other user of the configuration scoping application 202, the information typically is uploaded to the application configuration environment 102. However, in embodiments, where the configuration scoping application 202 executes on the same computing device as the application configuration environment 202, the scoping question answers and other information may be stored directly to the application configuration environment 102.

When the configuration question answers and other information is uploaded, or otherwise stored to the application environment 102, the scoping question answers are stored to the scoping input database 226. The scoping question answers, in some instances, will be referred to interchangeably as the “scoping information.”

After the scoping information is within the scoping input database 226, a process within the application configuration environment 102 typically executes to begin configuring an application in the configuration repository 242 of the configuration workspace 228. The configuration repository 242 may include a set of configuration tables that mirror, at least in part, the configuration tables of the application. The configuration repository 242 may include a set of configuration tables for each of multiple instances of the application to allow use of the application configuration environment 102 to configure multiple application instances.

The process that configures the application may be configured to determine one or more configuration packages to instantiate in the configuration repository 242. Configuration packages, in some embodiments, may include one or a set of configuration settings to enable or disable certain capabilities of the application. Configuration packages, as mentioned above, may be linked to adaptation catalog 214 entries and rules associated with adaptation catalog entries. Thus, the process that configures the application in the configuration repository 242 may be configured to query the scoping information in the scoping input database 226 to identify configuration packages to instantiate.

In some embodiments, demonstration data may exist to facilitate instantiation of a demonstration instance of the application for a sales lead, training session, or other purpose. The demonstration data, in some embodiments, is linked to one or more configuration packages from the configuration package repository 224. The demonstration data typically exists in the content repository 222 so that it can be copied into a set of application tables in the data repository 244 of the configuration workspace 228. These tables may hold such data as transactional data, operational data, master data, or other data that can exist in the application when the application is ready for execution or is executed.

Once the demonstration data is copied to the data repository 244, that data may be fine-tuned to more closely match the intended use of the demonstration data. For example, the system may be configured so that a sales person, or other individual, can fine-tune demonstration data values to more closely match a sales lead's expectations of the application. Such fine tuning may include modifying sales order documents in the demonstration data to include a name, address, and logo of the sales lead's enterprise, or other similar modifications to the demonstration data.

Some embodiments of the application configuration environment 102 may further include the deployment datastore 240. The deployment datastore 240 typically stores a representation of one or more application configurations of applications that have been deployed. The representations of the one or more application configuration may be stored or updated in the deployment datastore 240 by the deployment module 230 upon successful deployment of an application.

A representation of an application configuration typically includes data representative of the application configuration settings. In some embodiments, the representation may further include data representative of content deployed to the application.

The deployment datastore 240, in some embodiments, may be updated upon each configuration or content modification of a deployed system. In some embodiments, the deployment datastore may further include a versioning mechanism that maintains not only a current configuration representation, but also historical representations.

In some embodiments, the deployment datastore 240, or a current copy thereof, may be maintained by an entity that developed, or otherwise offers for sale, the application. The deployment datastore 240 may be used by the entity to monitor current application usage, perform billing processes as a function of a current application configuration, provide application upgrade information based on portions of the application or content utilized, and for other purposes. In some embodiments, the entity may provide application updates, bug fixes, or other upgrades directly to a deployed application instance. Such updates, bug fixes, or other upgrades may be identified as relevant to a particular application instance as a function of the configuration representation in view of adaptation catalog 214 entries.

As described above, the configuration application 236, in some embodiments, may provide a set of tools via user interfaces to a user. The tools of the configuration application 236 typically allow the user to modify answers to scoping question answers stored in an input cache 220, the application configuration dataset 234, and the application transaction dataset 238. The application configuration dataset 234 may be populated with data copied from the configuration repository 242. The application transaction dataset 238 may be populated with data copied from either a demonstration dataset stored in the data repository 244 or from the content repository 222. The input cache 220, if separate from the configuration scoping application 202 may be populated with scoping information copied from the scoping input database 226.

Through use of the configuration application 236 user interfaces, a user may modify data within the application transaction dataset 238 to customize the data used of a demonstration application to more closely reflect how a sales lead's enterprise will use the application. For example, through modifying the transaction data, data displayed within the demonstration may include orders with products, customers, addresses, countries, and other details that truly reflect those of the sales lead's enterprise.

Further, use of the configuration application 236 user interfaces may also allow a user to further refine an application configuration to more closely match the needs of a customer or sales lead. This can include a user taking a copy of an application configuration to work on while away from a connection to the application to be configured or application configuration environment 102, such as when traveling.

In some embodiments, the configuration application 236 may further include a warehouse-modeling module. The warehouse-modeling module may include a deduction engine 212 and a subset of an adaptation catalog 214 as discussed above, or may leverage the deduction engine 212 and adaptation catalog 214′ of the configuration scoping application 202 if present on the portable computing device 232. In such embodiments, the adaptation catalog 214 (or 214′) may further include one or more area, package, topic, option hierarchies of adaptation catalog 214 entries. The user may answer scoping questions to identify and define a warehouse layout and processes utilized within a warehouse to be modeled. Such warehouse modeling data, once defined, may be copied to the data repository. In some embodiments, such information is similar to configuration settings as a warehouse layout is not subject to frequent change. However, warehouse layouts are generally unique to each warehouse. Thus, warehouse data may be stored in the data repository and may be deployed to an application data table instead of a configuration table.

FIG. 2C is a block diagram of a system 260 according to an example embodiment. The system 260 includes the application configuration environment 102 as described above with reference to FIG. 1, FIG. 2A, and FIG. 2B. The system 260 further includes the content subscription server 106 as described above with reference to FIG. 1 and FIG. 2A, but provides greater detail with regard to the various elements of the content subscription server 106 according to some embodiments.

The content subscription server 106 may include a content database 246, a database of application instance configurations 248, a database of content subscription preferences, and a content subscription module 252. Some further embodiments may also include a copy of the scoping input database 226. Yet further embodiments may include an inbox module providing a location to place new content for download by an administrator or process of an application configuration environment 102.

The content subscription server 106 is typically operatively coupled to the application configuration environment 102. In some embodiments, the coupling of the content subscription server 106 to the application configuration environment 102 may be made over a network connection 254 between the computing systems upon which they operate. In some embodiments, the network connection 254 is an Internet connection. In other embodiments, the network connection 254 may a connection to one or more of a variety of networks including a local area network (“LAN”), a wide area network (“WAN”), a value added network (“VAN”), a peer-to-peer network (“P2P”), or other suitable network providing data exchange functionality.

The content database 246 typically is a location to which new content is published. Content published to the content database 246 is content that may be processed by the content subscription module 252 and pushed, or otherwise made available, to one or more application instances via their respective application execution environments. As mentioned above, when content is published, the content may include metadata identifying what portions of an application the content is relevant to or otherwise has an effect upon.

The instance configuration settings database typically includes data representative of application instance configurations. In some such embodiments, the data representative of the application instance configurations may include data representative of content deployed to the respective application instances.

The content subscription module 252 typically evaluates the metadata of the content published to the content database. The content subscription module may then query the instance configuration settings database 248 to determine which application instances the new content is relevant to. The new content may then be distributed to the application configuration environments of the identified application instances. The application configuration environment may then deploy the new content.

In embodiments that include a copy of the scoping input database 226, the content subscription module 252 is typically configured to evaluate the scoping information to determine if the published content is relevant to one or more application instances. Depending on the metadata of the published content, this evaluation may identify content relevant to an application instance not identified by the evaluation of the instance configuration settings database 248. Such an identification may occur when a new item of content is published that was not included in the representation of the application instance configuration settings. Such an identification may also occur when the published content is an item of previously existing content whose metadata has been modified.

In embodiments including the content subscription preferences database 250, when an application instance is instantiated, an application administrator, or other individual, may set up a content subscription. A content subscription may include a specification of content subscription preferences that are stored in the content subscription preference database 250. These preferences typically identify how to handle new content when new content is published to the content database 246.

In some embodiments, the content subscription preferences may specify that new content identified by the content subscription module 252 to be relevant to the application instance be pushed to the application configuration environment 102. In some such embodiments, when new content is pushed to the application configuration environment, a content subscription preference may specify that the new content be automatically deployed to the application execution environment 104 by the deployment module 230. In other embodiments, the preferences may specify that the pushed content is to be stored in an administrator inbox. In these embodiments, the administrator, or other individual may manually instruct the deployment module 230 to deploy the new content. In some other embodiments, a content subscription preference may specify for the new content to be placed in a new content inbox. The new content inbox may be located on the content subscription server 106 or other server from which the new content may be accessed for download. In such instances, an application instance administrator may receive a message including a new content notice. The administrator may then go to the designated download location and download the content. The content may then be manually or automatically deployed by the deployment module 230.

In some embodiments, the subscription preferences may specify that new content be sent to an application instance administrator on a computer readable medium, such as via an email, on a computer disk, or other suitable medium. In such instances, the new content may be copied from the computer readable medium to the application configuration environment 102 and deployed in due course.

FIG. 2D is a block diagram of a system 262 according to an example embodiment. The system 262 includes the content subscription server 106 as described above with reference to FIG. 1, FIG. 2A, and FIG. 2C. The system 262 further includes the content authoring application 204 as described above with reference to FIG. 2A, but provides greater detail with regard to the various elements of the content authoring application 204 according to some embodiments.

The content authoring application 204 typically includes a user interface module 264, an adaptation catalog 214″, a content repository 222″, and a configuration package repository 224″. The adaptation catalog 214″, the content repository 222″, and the configuration package repository 224″ typically are the originating sources of this data described elsewhere herein. Content, including adaptation catalog entries, configuration packages, and other content, may be authored, modified, and deleted utilizing one or more user interfaces of the user interface module 264.

When a user creates, modifies, or deletes content utilizing the content authoring application 204, the content is typically stored into or deleted from the adaptation catalog 214″, the content repository 222″, and the configuration package repository 224″. Note that adaptation catalog 214″ entries and configuration packages stored in the configuration package repository 224″ are both content types. Thus, when content is referred to in the present application, unless explicitly excluded or otherwise called out, adaptation catalog 214″ entries and configuration packages are included.

In some embodiments, after the content is stored, the content may be verified via quality control processes of the organization utilizing the content authoring application. The content may then be published the content database 246 of the content subscription server 106. The content subscription server 106 may then operate upon the new content to distribute it. In some embodiments, the content may be part of a baseline application that may be instantiated for new application instances.

FIG. 2E is a block diagram of a system 270 according to an example embodiment. The system 270 includes the content authoring application 204 as described above with reference to FIG. 2A and FIG. 2D. The system 270 further includes the application configuration environment 102 as described above with reference to FIG. 1, FIG. 2A, FIG. 2B, and FIG. 2C.

In some embodiments of the system 270, content is typically stored directly to the application configuration environment 102. This storing may include copying one or more of the adaptation catalog 214″, content repository 222″, and configuration package repository 224″ from the content authoring application 204 to the adaptation catalog 214, content repository 222, and configuration package repository 224 of the application configuration environment 102.

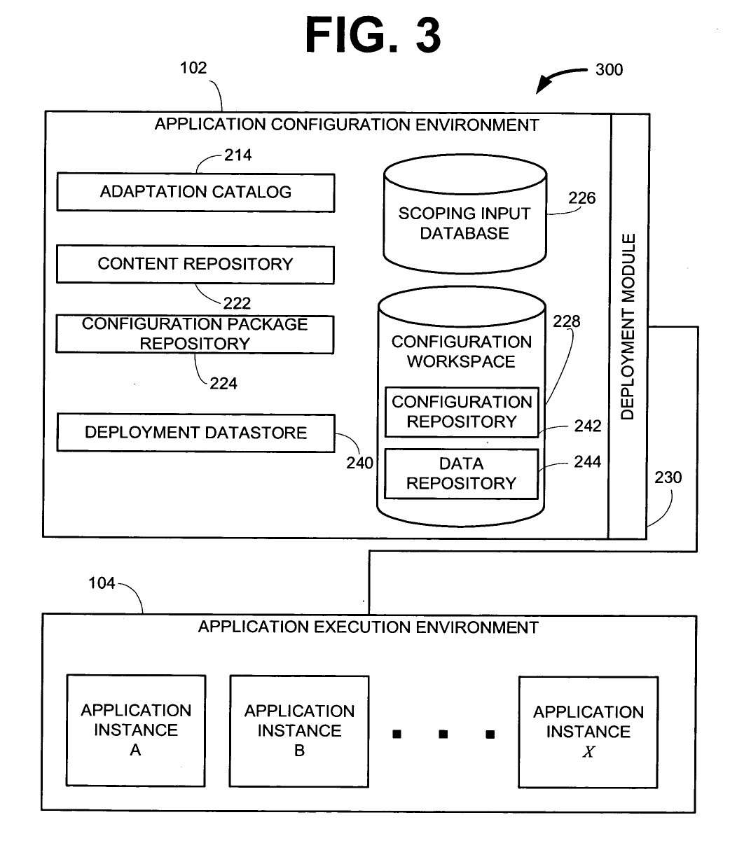

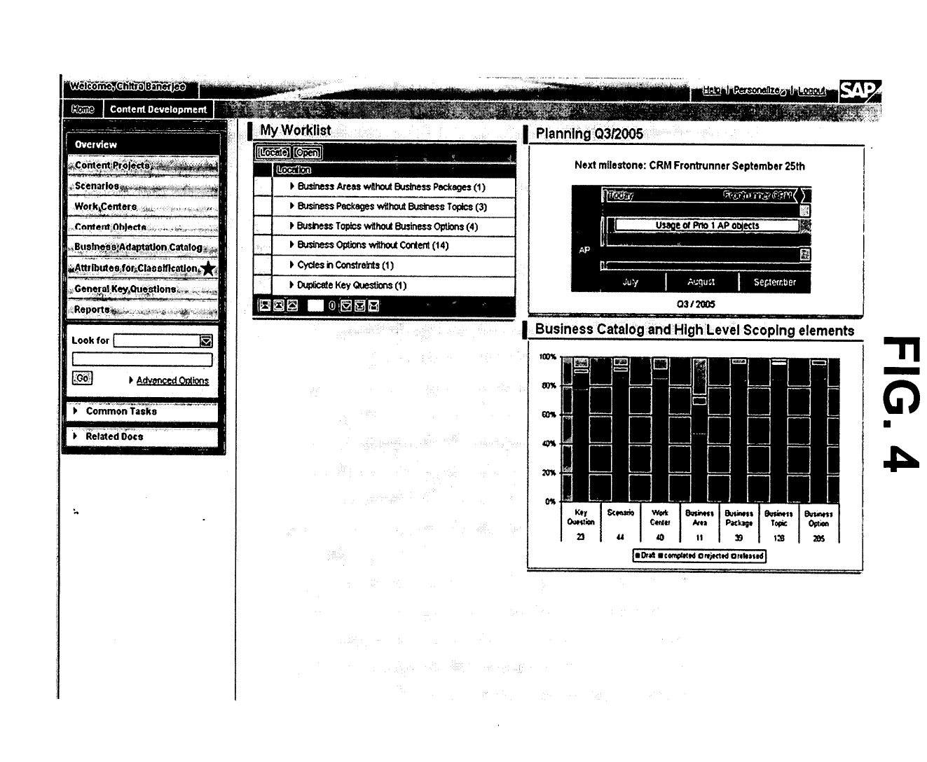

FIG. 3 is a block diagram of a system 300 according to an example embodiment. The system 300 includes the application configuration environment 102 as discussed above with regard to FIG. 1, FIG. 2A, FIG. 2B, and FIG. 2C. The system 300 further includes the application execution environment 104.

The application execution environment 104 is a data processing environment within which an application, or an application to be deployed, may execute. When deploying an application, the deployment module 230 typically needs to know what application execution environment 104 and what application instance within that environment to deploy to. In embodiments including only one application execution environment 104, the application execution environment 104 may already be known. Similarly, in an application execution environment including only a single application instance, the instance may already be known.

Each instance of the application (i.e., application instances A, B . . . X) typically includes a set of identical configuration tables which may include distinct configuration settings from one another. In some embodiments, multiple instances of the application may exist such as to provide a development instance, a test instance, and a production instance. In such embodiments where there are multiple application instances, the deployment module 230 may deploy the configuration settings from one of the application instances in the application execution environment 104 to another application in the same or another application execution environment 104. Although the deployment module 230 is illustrated as being a part of the application configuration environment 102, the deployment module 230, in other embodiments, may be a standalone application or a part of another application or process.

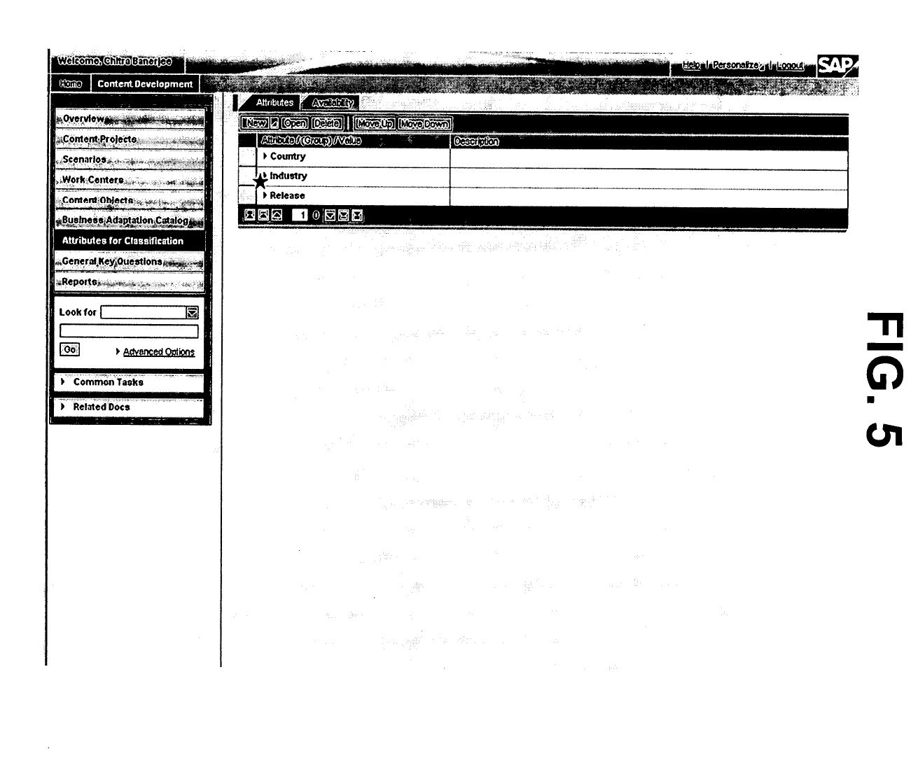

FIG. 4-FIG. 22 illustrate example user interfaces according to example embodiments. One or more of these user interfaces may be included with the content authoring application 204 as described above with reference to FIG. 2A, FIG. 2D, and FIG. 2E.

The user interface of FIG. 4 illustrates a content development work center. This user interface allows a user to view several items of data including a work list of work assigned to the user. The user interface further provides a view of the status of one or more projects and a view of upcoming project critical dates.

The user interface of FIG. 4 further provides links to other user interfaces of the content authoring application. Some such links include links to view content projects, scenarios, other work centers, content objects, the business adaptation catalog, attributes for classification, general key questions, and reports.

An attribute for classification can include a new item to place in the adaptation catalog. In some embodiments, this includes an item to be classified as an area, package, topic, or option. Classifying such an item may require definition and classification of other items lower in the area, package, topic, and option hierarchy depending on the level in the hierarchy the item is classified into.

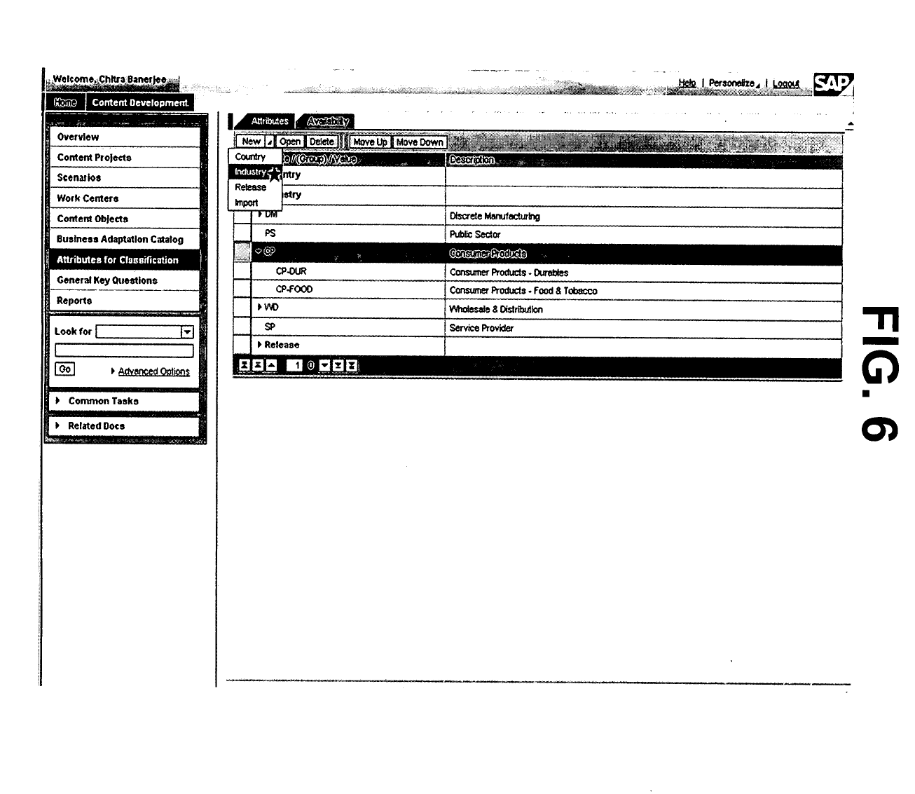

The user interface of FIG. 5 provides a user interface for use in beginning classification of an item. For example, if item to classify is food consumer product, the user interface is used to drill down into the area, package, topic, option hierarchy. In this example, the user chooses to classify the food consumer product by industry. Thus, the user selects “Industry” within the user interface to expand the hierarchy.

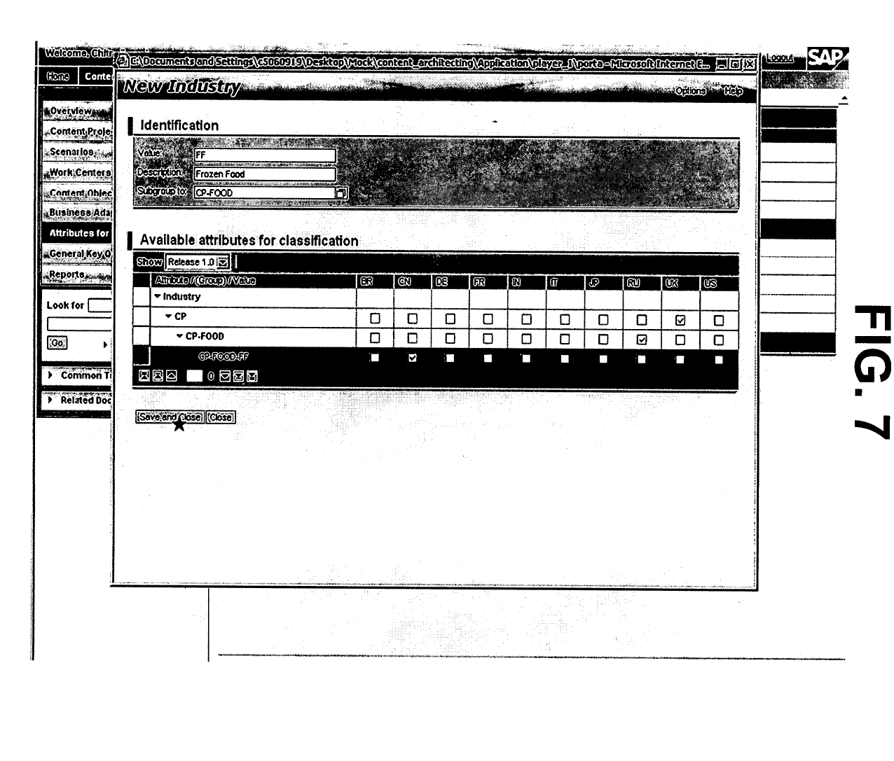

FIG. 6 provides another user interface for use in classification of the item. The expansion of the hierarchy can be seen in this user interface. The hierarchy under industry includes the industry “CP,” or consumer products. In the hierarchy under “CP” is “CP-FOOD” to classify items within the hierarchy as food and tobacco consumer products. However, in this instance, the user is classifying a frozen food consumer product that has specific handling requirements. Thus, the user chooses to create a new industry identifier within the hierarchy under “CP-FOOD.”

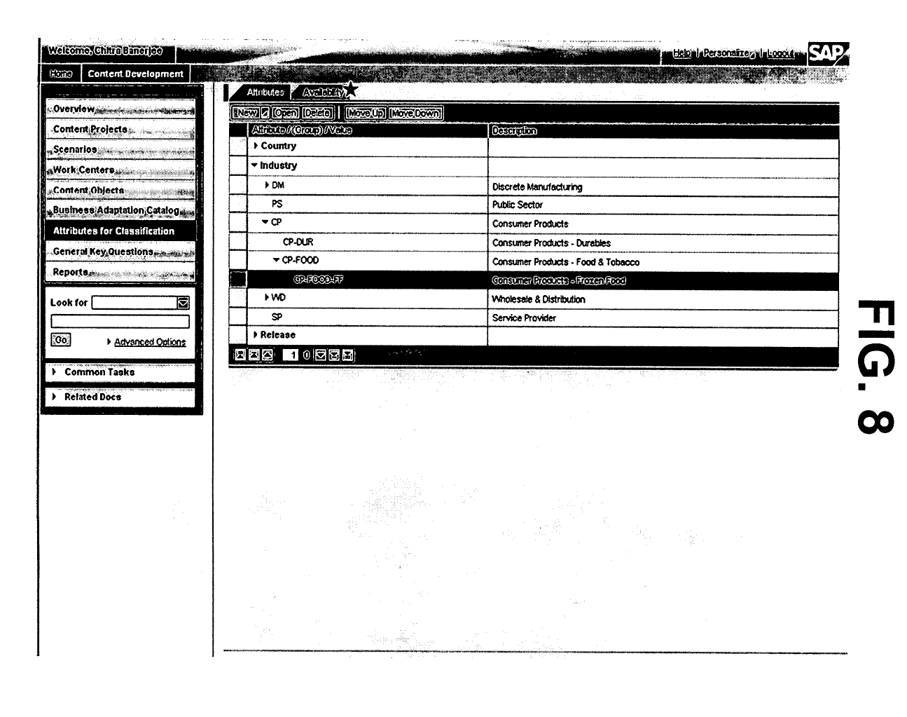

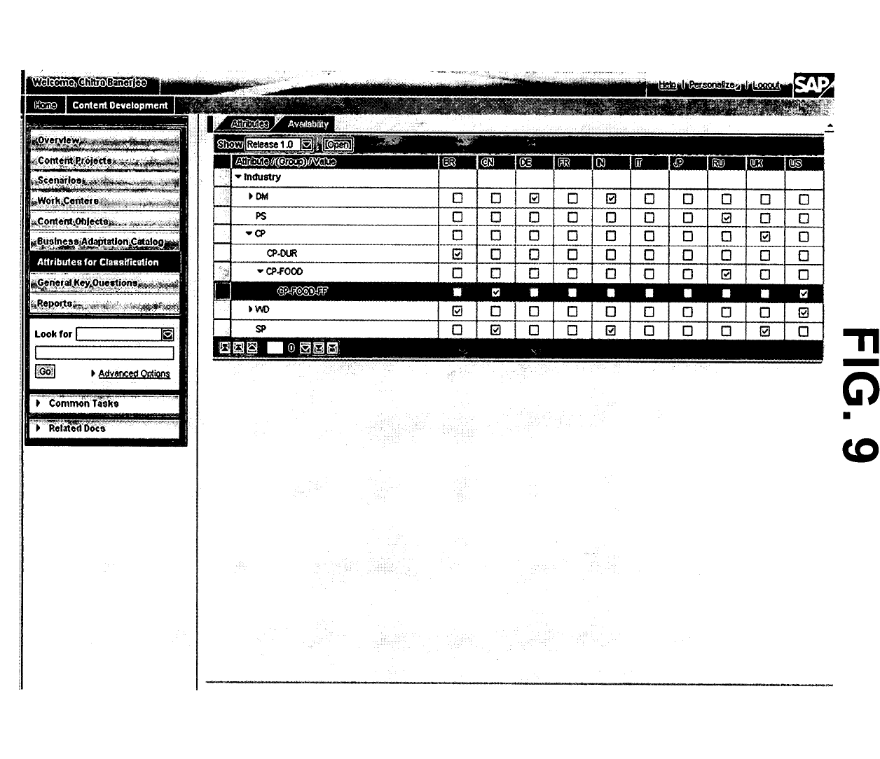

FIG. 7 provides a user interface for creating the new industry identifier within the hierarchy. The new industry identifier will be named in the hierarchy as “CP-FOOD-FF” for “consumer product, food, frozen food.” The user can add identification data and attributes for this new industry identifier using the user interface of FIG. 7. The new industry identifier is then saved, such as to the adaptation catalog, and is viewable within the hierarchy in the example user interface of FIG. 8. The user then selects the new industry identifier in the user interface of FIG. 8 and selects the availability tab to add further data regarding when the new industry identifier will be available when configuring an application.

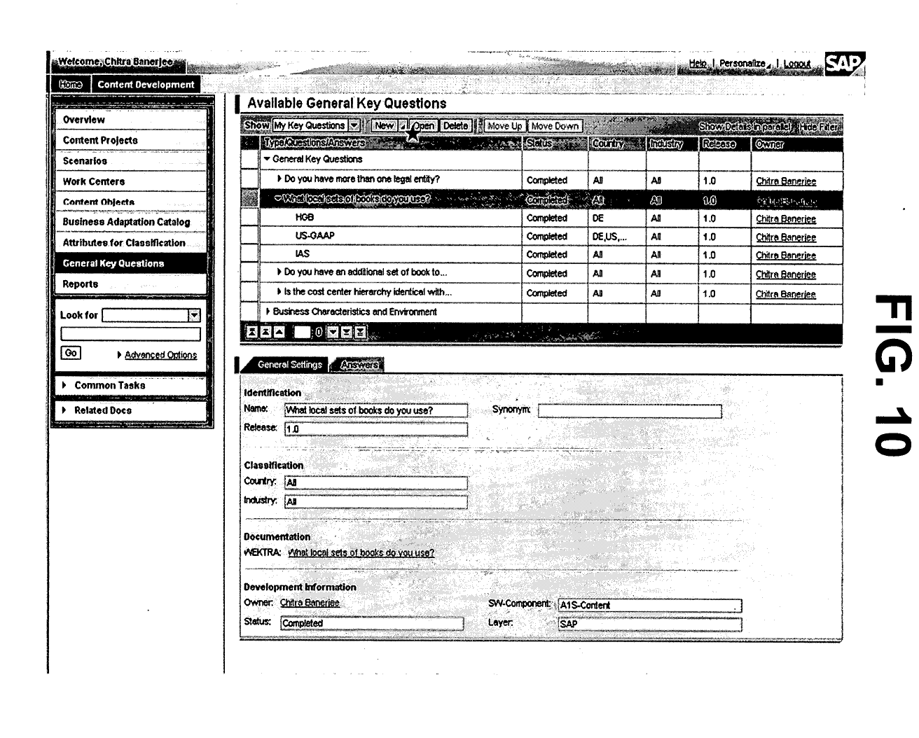

FIG. 9 provides a user interface for designating what countries the new industry identifier is relevant to. The user can select one or more country identifiers. The country identifiers are then stored to the adaptation catalog, or other content storage location. These country identifiers will later be used when scoping information is being collected, such as when receiving an answer to a scoping question that identifies a country within which an organization operates. The country identifier can then be used to either cause inclusion or exclusion of the new industry identifier, and application capabilities that will be later associated with the industry identifier, in an application configuration.

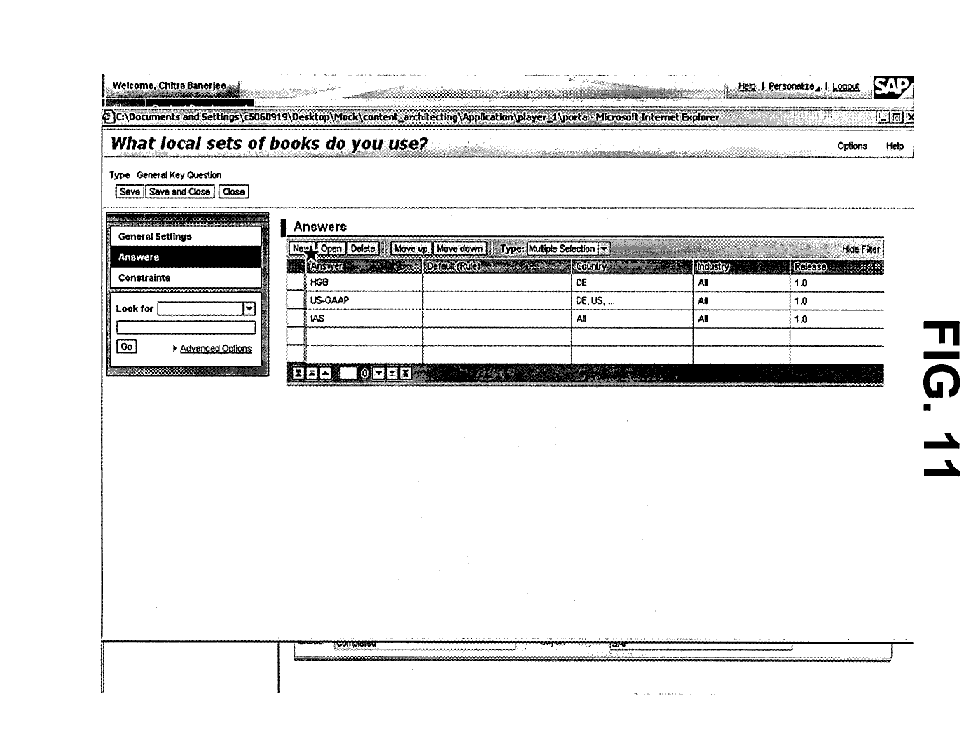

FIG. 10 provides a user interface for use in authoring, modifying, and deleting scoping questions. This user interface can be navigated to from the work center user interface of FIG. 4 by selecting the “General Key Questions” link.

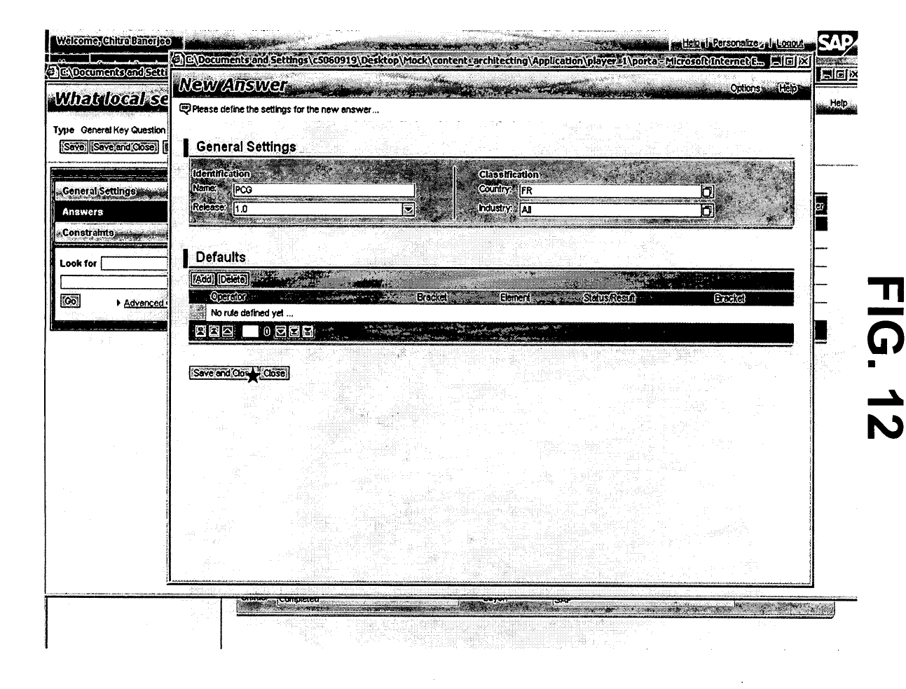

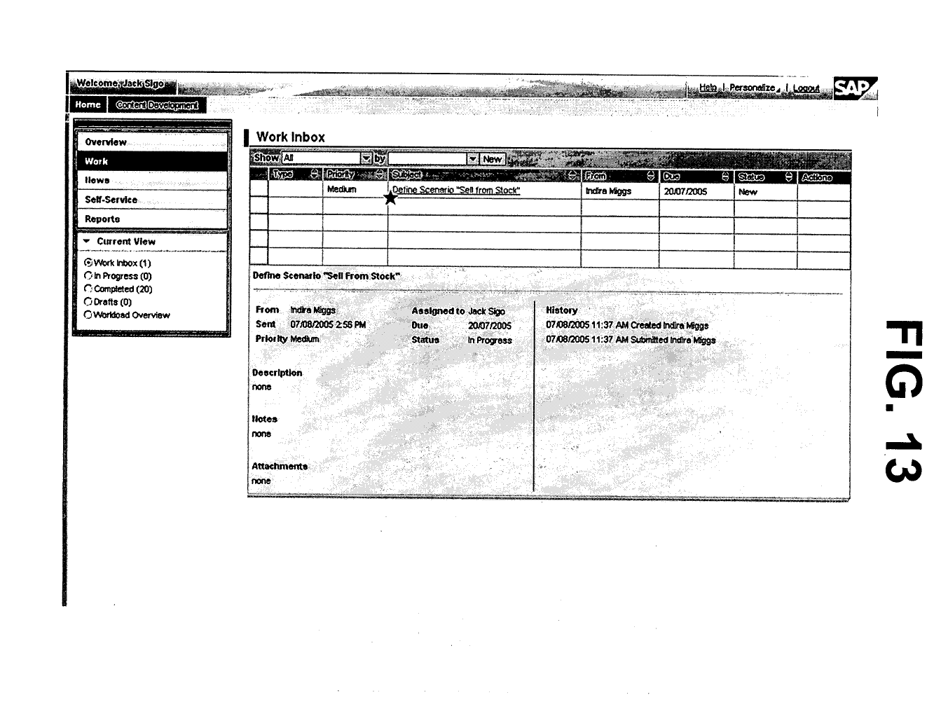

In some embodiments, the questions are organized in a hierarchy. The hierarchy, in some embodiments correlates to an area, package, topic, and option hierarchy. The user can select a question and expand the hierarchy to view possible question answers. The user can modify details regarding a question with the user interface of FIG. 10. The user can use the user interface of FIG. 11 to add, modify, and delete possible question answers. The user interface of FIG. 12 can be used to define rules associating a possible question answer to other items of content, such as a configuration package.

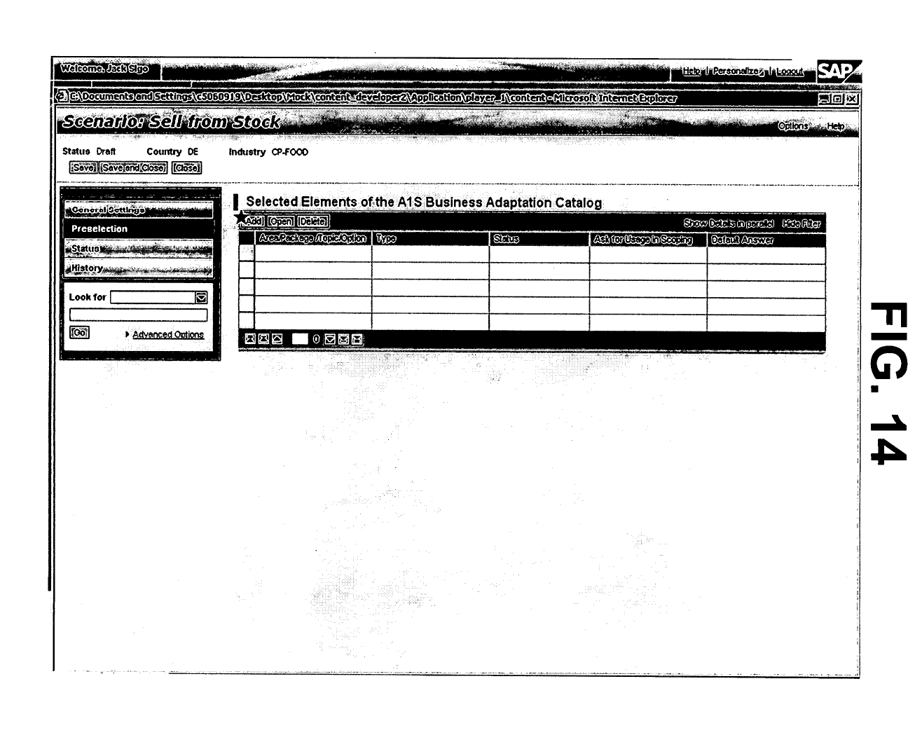

FIG. 13 illustrates a user interface that provides a work inbox view of a user's assigned work. A user can select an item displayed in the inbox and view details of the work assignment. In this embodiment, a link is provided within the illustrated work assignment to view details of the assigned work assignment.

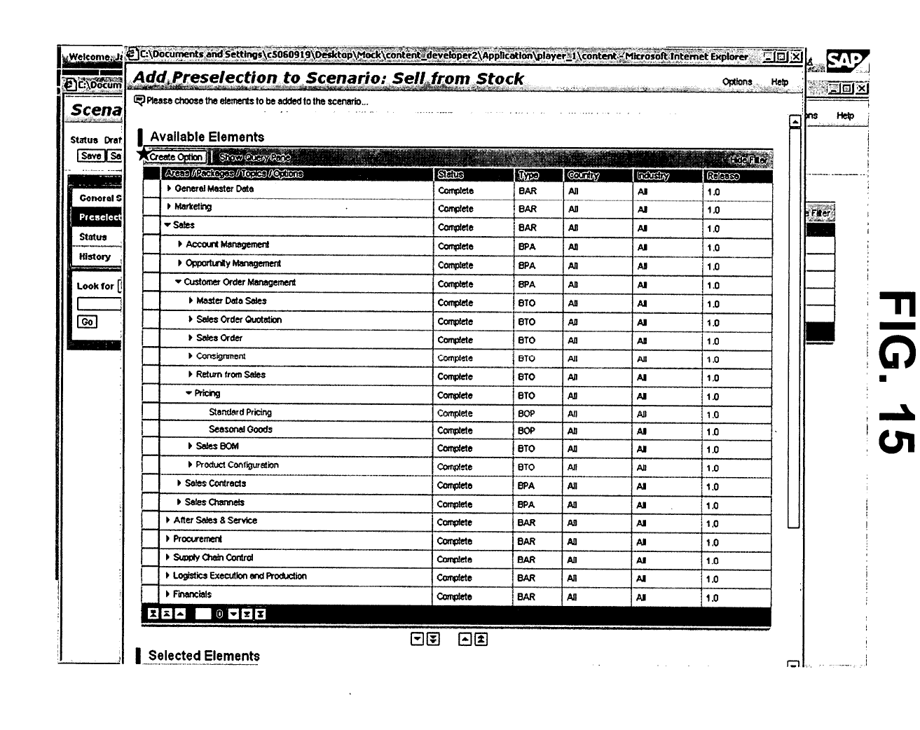

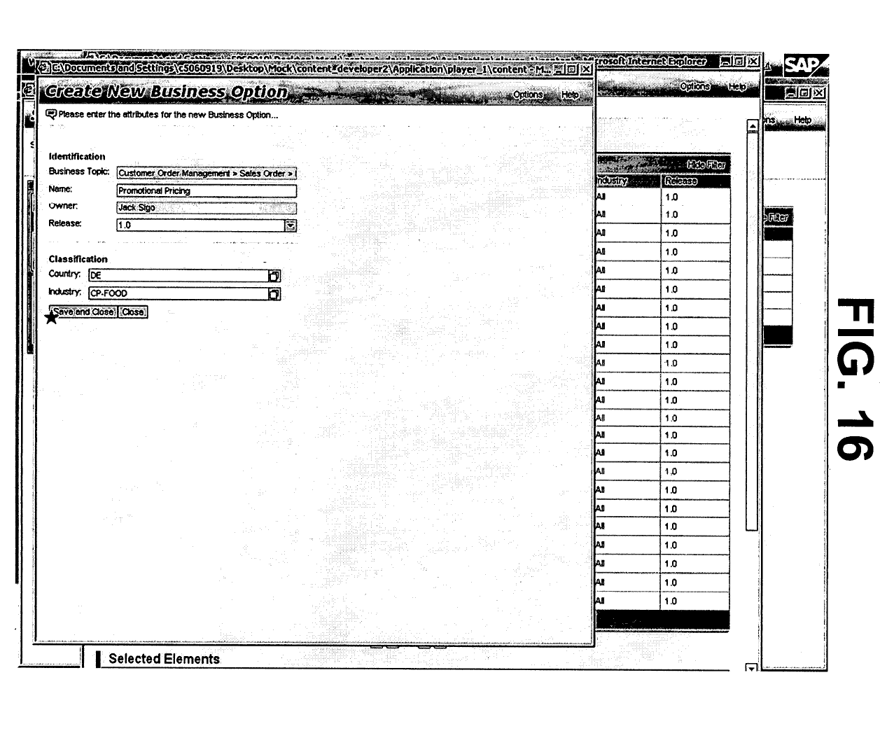

FIG. 14 illustrates a user interface that allows a user to further refine an adaptation catalog entry. This user interface displays selected elements, such as options, of the adaptation catalog linked to an item, such as a topic. The add button of the user interface can be selected to add additional elements. This causes the user interface of FIG. 15 to be displayed.

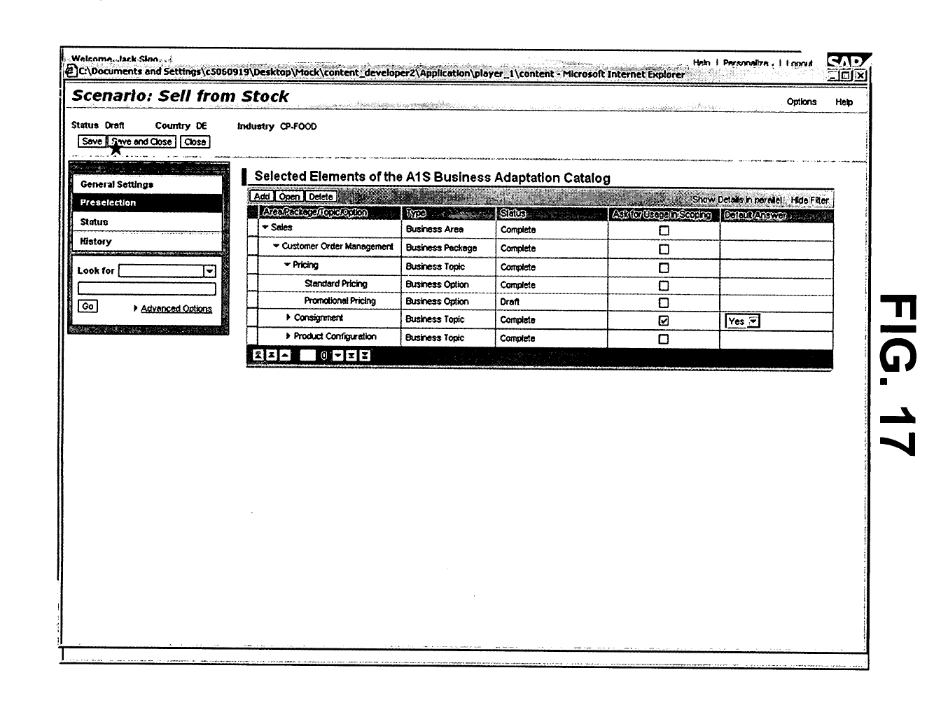

The user interface of FIG. 15 displays a list of available elements, and some details thereof. Elements, such as options, can be selected from this list to be linked to a parent item, such as a topic. If a user cannot find a desired element, such as an option, in the list of available elements, a new element can be created by selecting the “Create Option” button, which causes the user interface of FIG. 16 to be displayed. After the new element is defined using the user interface of FIG. 16, the element will then be listed as available in the user interface of FIG. 15 and can be selected to be linked to the parent item.

When elements are defined using the user interface of FIG. 16, or other items, elements, areas, packages, topics, options, or other content using any of the described user interfaces, attributes can be associated with them. These attributes, in some embodiments, become part of one or more adaptation catalog entries or rules associated with content. The adaptation catalog entries and rules are later leveraged when collecting scoping information and configuring applications as described above.

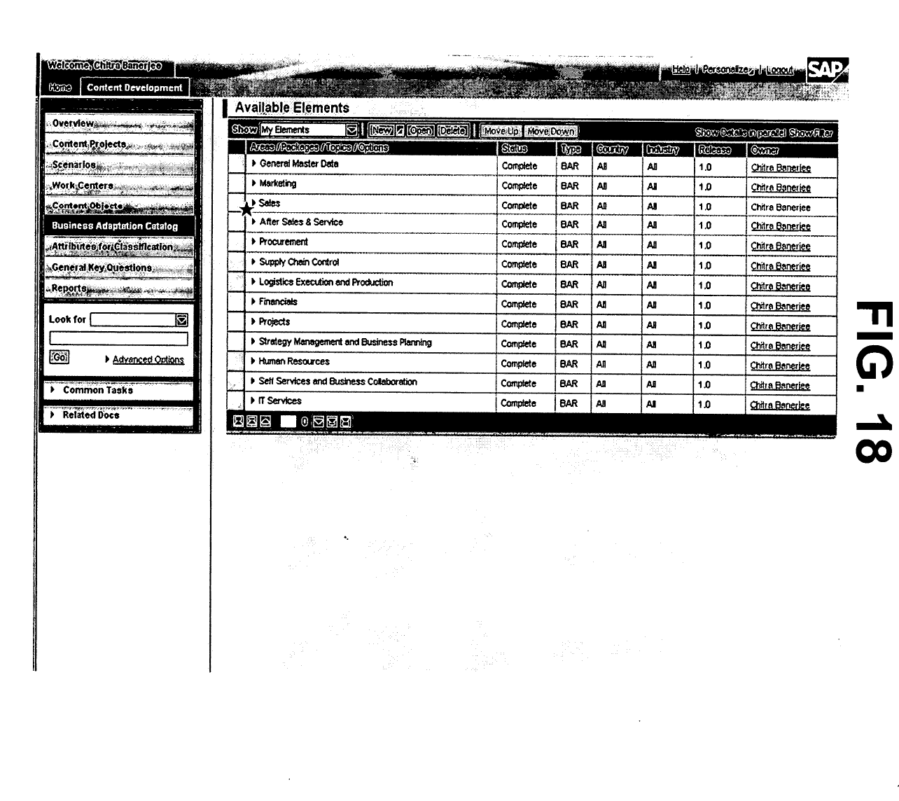

FIG. 17 illustrates a user interface that allows a user to specify default elements within an adaptation catalog. This can include default options when a particular topic is selected for inclusion in an application configuration.

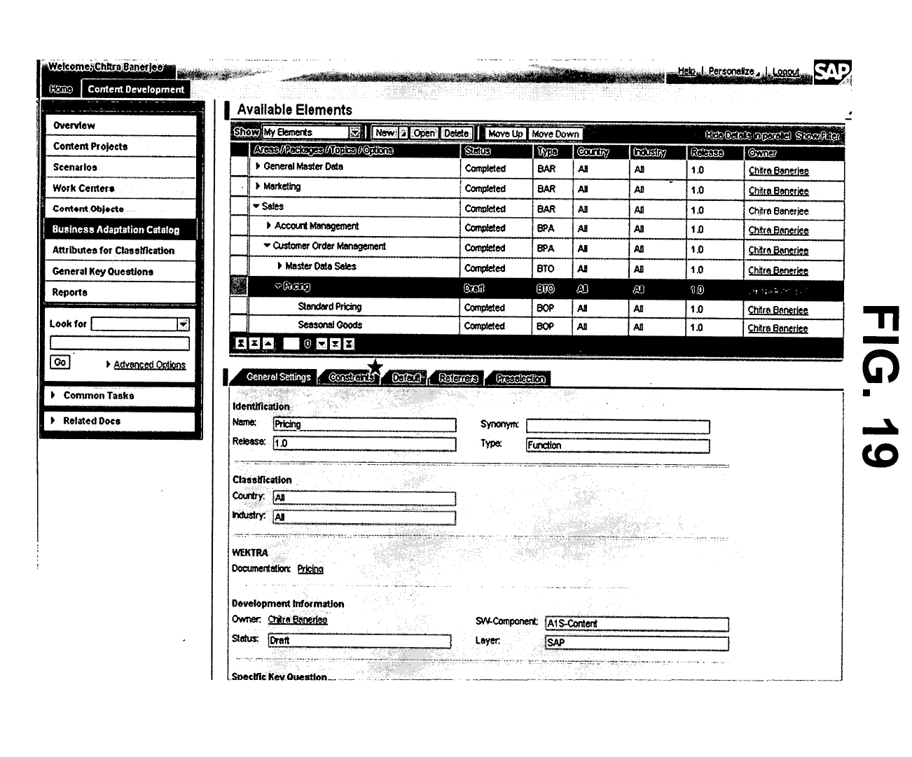

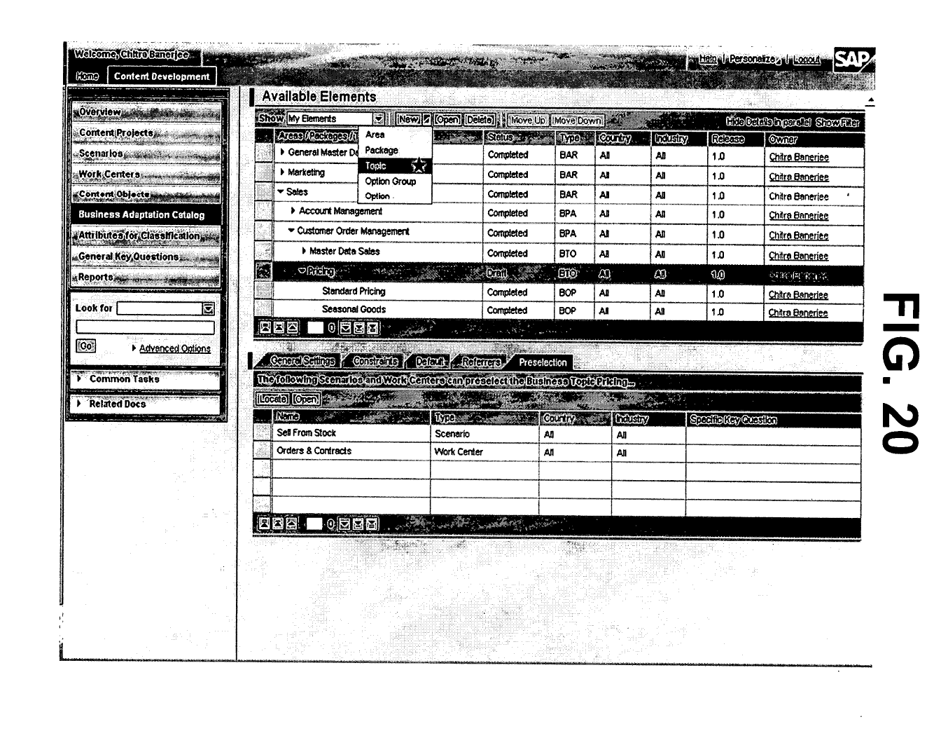

FIG. 18 illustrates a user interface that allows a user to view and modify the adaptation catalog. The adaptation catalog is displayed as a hierarch of areas, packages, topics, and options within the user interface. A user can expand the hierarchy to view lower level elements of the adaptation catalog. Elements of the adaptation catalog are also referred to herein as adaptation catalog entries. A user can further select an adaptation catalog element to view details associated with it. These details can be viewed and modified within the user interface of FIG. 19.

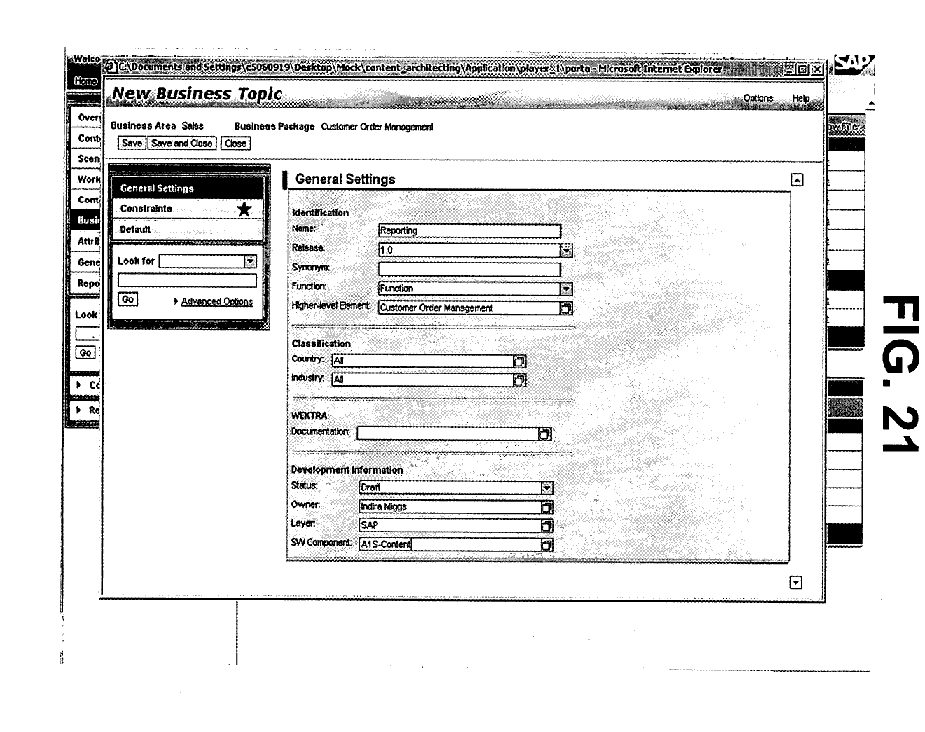

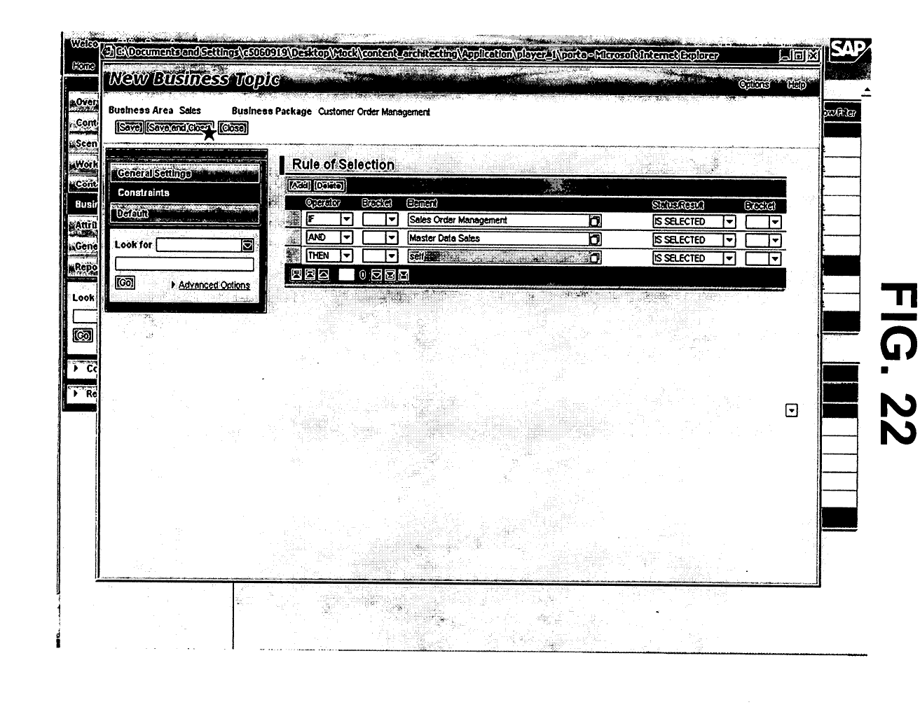

Another view of the user interface 18 is provided in FIG. 20. In the user interface of FIG. 20, the user has selected the new button. This causes a menu to be displayed allowing a user to specify what element type the user wants to create. In this instance, the user selected “Topic” to create a new topic. This causes the user interface of FIG. 21 to be displayed.

The user interface of FIG. 21 provides a screen to input data to define a new topic. If the user chooses to attach a constraint or rule to the topic, the user interface of FIG. 22 is displayed.

The user interface of FIG. 22 includes a set of drop down boxes that can be used to define a rule or constraint. The boxes allow the user to specify logical relationships between adaptation catalog elements to cause a result, such as selection of another element. In some embodiments, the logical relationships take the form of “IF . . . THEN . . . ” statements.

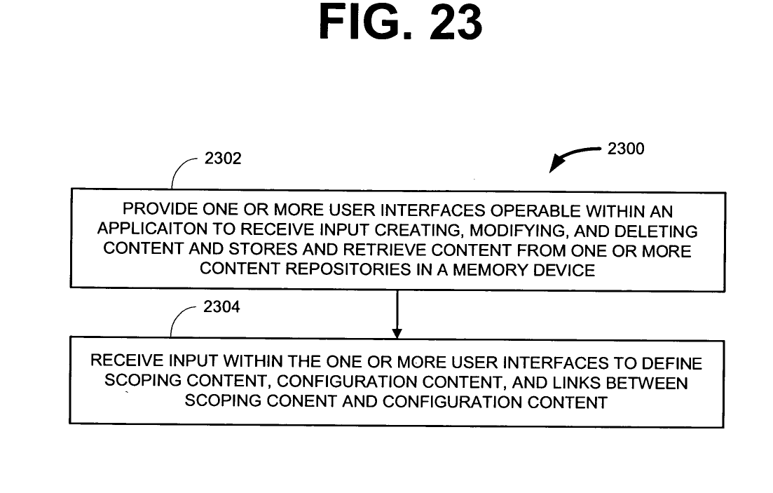

FIG. 23 is a flow diagram of a method 2300 according to an example embodiment. The example method 2300 includes providing one or more user interfaces. In some embodiments, the user interfaces are operable to receive input creating, modifying, and deleting content. The user interfaces are further operable to store and retrieve content from one or more content repositories in a memory device. The method 2300 further includes receiving, within the one or more user interfaces, input defining scoping content, configuration content, and links between scoping content and configuration content.

In some embodiments, an item of content can be created that is inherited from another item of content. In such embodiments, the content is extendable. For example, a first user interface content item displays ten data items and is the parent item of content. A second user interface content item inherits the properties of the first user interface and is the child content item. However, one of the data items from the parent user interface is designated as invisible within the child user interface. In some such embodiments, an extended child content item includes an identifier of the parent content item it is inherited from. In such an embodiment, only differences between the parent content item and the child content item.

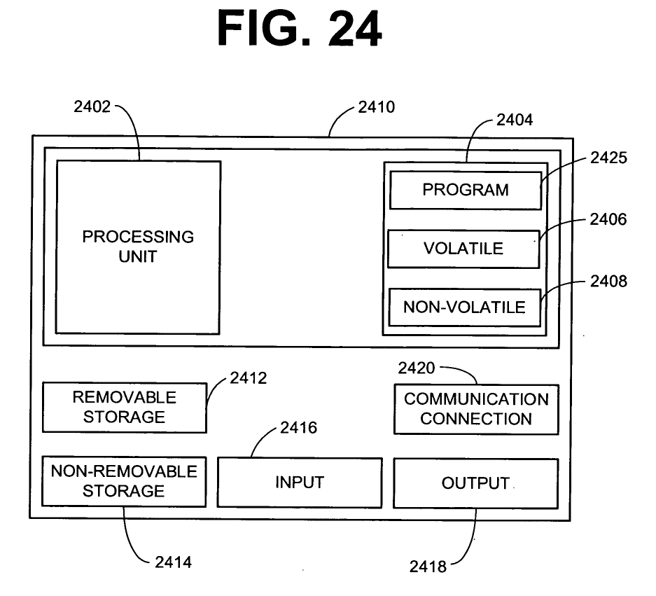

FIG. 24 is a block diagram of a computing device according to an example embodiment. In one embodiment, multiple such computer systems are utilized in a distributed network to implement multiple components in a transaction based environment. An object oriented architecture may be used to implement such functions and communicate between the multiple systems and components. One example computing device in the form of a computer 2410, may include a processing unit 2402, memory 2404, removable storage 2412, and non-removable storage 2414. Memory 2404 may include volatile memory 2406 and non-volatile memory 2408. Computer 2410 may include—or have access to a computing environment that includes—a variety of computer-readable media, such as volatile memory 2406 and non-volatile memory 2408, removable storage 2412 and non-removable storage 2414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2410 may include or have access to a computing environment that includes input 2416, output 2418, and a communication connection 2420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2402 of the computer 2410. A hard drive, CD-ROM, and RAM are some examples of articles including a computer-readable medium. The term “computer readable medium” is also used to represent carrier waves on which the software is transmitted. For example, a computer program 2425 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 2410 to provide generic access controls in a COM based computer network system having multiple users and servers.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A system comprising:
a memory;
a content authoring module, wherein the content authoring module:
provides one or more user interfaces operable to receive input
creating, modifying, and deleting content; and
stores and retrieves content from one or more content repositories in the memory;
wherein the content authoring module receives input via the one or more user interfaces to define:
scoping content;
configuration content; and
links between scoping content and configuration content.

2. The system of claim 1, wherein content is extensible.

3. The system of claim 2, wherein extended content includes only differences between a parent content item and a child content item.

4. The system of claim 1, wherein the one or more user interfaces operable to receive input creating, modifying, and deleting content include:
a user interface operable to receive input defining scoping content;
a user interface operable to receive input defining a link between scoping content and a configuration dataset.

5. The system of claim 4, wherein a configuration dataset includes one or more configuration settings that enable a portion of system functionality.

6. The system of claim 1, wherein the one or more user interfaces operable to receive input creating, modifying, and deleting content include;
a user interface operable to receive input defining a target system user interface.

7. The system of claim 6, wherein the target system user interface is a data input user interface.

8. A method comprising:
providing one or more user interfaces operable within an application to:
receive input creating, modifying, and deleting content;
store and retrieve content from one or more content repositories in a memory device; and
receiving, within the one or more user interfaces, input defining:
scoping content;
configuration content; and
links between scoping content and configuration content.

9. The method of claim 8, wherein content is extendable.

10. The method of claim 9, wherein extended content includes only differences between a parent content item and a child content item.

11. The method of claim 8, wherein the one or more provided user interfaces operable to receive input creating, modifying, and deleting content include:
a user interface operable to receive input defining scoping content;
a user interface operable to receive input defining a link between scoping content and a configuration dataset.

12. The method of claim 11, wherein a configuration dataset includes one or more configuration settings that enable a portion of system functionality.

13. The method of claim 8, wherein the one or more provided user interfaces operable to receive input creating, modifying, and deleting content include a user interface operable to receive input defining a target system user interface.

14. The method of claim 13, wherein the target system user interface is a data input user interface.

15. A machine-readable medium, with instructions thereon, which when executed, cause a machine to:
provide one or more user interfaces operable within an application to:
receive input creating, modifying, and deleting content;
store and retrieve content from one or more content repositories in a memory device;
receive, within the one or more user interfaces, input defining:
scoping content;
configuration content; and
links between scoping content and configuration content.

16. The machine-readable medium of claim 15, wherein content is extendable.

17. The machine-readable medium of claim 16, wherein extended content includes only differences between a parent content item and a child content item.

18. The machine-readable medium of claim 15, wherein the one or more provided user interfaces operable to receive input creating, modifying, and deleting content include:
a user interface operable to receive input defining scoping content;
a user interface operable to receive input defining a link between scoping content and a configuration dataset.

19. The machine-readable medium of claim 18, wherein a configuration dataset includes one or more configuration settings that enable a portion of system functionality.

20. The machine-readable medium of claim 15, wherein the one or more provided user interfaces operable to receive input creating, modifying, and deleting content include a user interface operable to receive input defining a target system user interface.
